(19) United States
(12) Patent Application Publication
(10) Pub. No.: US 2002/0184642 A1
(43) Pub. Date: Dec. 5, 2002

(54) Method and apparatus for opportunistically broadcasting rich media digital content

(76) Inventors: Peter J. Lude, San Francisco, CA (US); Daniel A. Radke, Manhattan Beach, CA (US); Noam A. Shendar, Mountain View, CA (US); Michael K. Stauffer, Palo Alto, CA (US)

Correspondence Address: Wen Liu, LIU & LIU LLP, Suite 1100, 811 West 7th Street, Los Angeles, CA, 90017, US

(21) Appl. No.: 10/131,624

(22) Filed: Apr. 23, 2002

Related U.S. Application Data
(60) Provisional application No. 60/286,185, filed on Apr. 23, 2001.
(60) Provisional application No. 60/286,187, filed on Apr. 23, 2001.

(51) Int. Cl. H04N 7/173

(52) U.S. Cl. 725/105

(57) ABSTRACT

A method for digital data distribution or broadcasting that takes advantage of non-deterministic (or “opportunistic”) unused bandwidth in dynamically optimized broadband digital broadcast systems. Digital data files received from broadcasts are stored in mass storage devices for viewing at a later time at high speed, overcoming “last mile” narrow bandwidth issues. Instead of reserving a particular communications channel or data transfer spectrum, data is opportunistically “piggybacked” onto unrelated broadcasts, using otherwise unused bandwidth within existing broadcast channels or spectrums. The broadcast source does not target the digital files at specific identifiable users or broadcast contents based on their interactive requests. Data broadcasting in accordance with the present invention may be implemented to work with any medium which allows the delivery of large files in a one-to-many fashion (i.e., “broadband broadcast medium”), such as digital cable, digital broadcast satellite, terrestrial digital television, and computer networks that are broadcast-enabled and sufficiently broadband.

### BACKGROUND OF THE INVENTION

1. Field of the Invention

This invention relates to data broadcasting, and more particularly to a method and apparatus for opportunistically broadcasting rich media digital content.

2. Description of Related Art

Existing methods and devices for the transmission of digitized content each suffer from a number of inherent limitations on their ability to distribute rich digital content such as movies, video games, audio and other large digital files to large numbers of users quickly, efficiently and inexpensively. These limitations on file size and/or audience size present a significant barrier to the growth of electronic commerce for mass-market content and digital distribution.

While the Internet has emerged as a powerful tool for distribution of digital content, it is optimal when used as a means of transporting unique data from many sources to many destinations (many-to-many distribution) at a system level. However, at an operational level, the Internet is in effect point-to-point, based on one-to-one communication (i.e., in a unicast environment, in which a node has the ability to send to only one other node at a time). This means that a separate data stream must be reserved to serve each user individually during data transmission. For example, when a large group of N people want the same information, the information server has to send it out either N times or in a single operation as in multicasting to N specific client addresses, via N specific transmission paths. Technological limitations (including bandwidth) and the basic architecture of the Internet as a network of networks render it cumbersome and relatively expensive as a means for mass distribution of large digital files from a single source. The limitations even apply to mass simultaneous distribution of small digital files.

Methods have been developed to move content closer to the end user by storing copies of the content on multiple, geographically distributed servers, located for example at local Internet Service Providers (ISPs). This technique avoids the need to move the content from a single, centralized server through potentially a large part of the Internet to reach the user. Companies such as Digital Island, Akamai, and iBeam provide such systems. However, these systems still have a “last mile” bandwidth limitation problem. In fact, these companies have either shut down, gone bankrupt, or are in financial distress. While a number of methods have been developed for multi-cast distribution of rich content using transmission over coaxial cable, fiber optics and a variety of other broadband transmission systems, they do not solve the infamous “last mile” problem at the “edge” of the data network. A number of solutions, most notably DSL (digital subscriber line) and high speed cable access have emerged to attempt to address the last mile problem, but the effectiveness of these solutions have met with mixed results, due in part to their failure to address the unicast problem.

Further, past systems did not adequately address some of the practical aspects of data transmission that relates to the nature of the content, usage and applications based on the data network. For example, prior pay-per-view (PPV) systems exhibit significant limitations for transmitting programming content in near video-on demand (NVOD) or video-on-demand (VOD) systems. In conventional NVOD systems the user selects and orders content, such as a movie, from a predetermined schedule. The PPV provider transmits the content in real-time in accordance with the predetermined schedule, sometimes repeatedly transmitting the same content for use at predetermined times. When an order is placed, the purchased program is unscrambled by a proprietary decoding receiver and made available for viewing by the user in real-time.

VOD systems differ from NVOD systems in that the user may order any content from a list of available titles in the provider's library. For a true VOD system, the content is available at any time on demand by the user, and may be transmitted to the user in a number of ways, including both real-time transmission and burst transmission in a period of time that is substantially less than real-time. In many VOD systems, the user has enhanced control of use of the content as compared to real-time NVOD systems. For example, movies transmitted using a VOD system may be stored at the point of use, and thus the user may exercise VCR-type control during playback of the movie such as stop, pause and rewind functions. It is also possible to achieve such VCR-type control using real-time transmission by sending commands from client to server. While convenient to users, VOD systems are complex, costly and relatively inefficient in both server utilization and transmission bandwidth.

U.S. Pat. No. 5,710,970 to Walters sought to overcome some of these limitations of NVOD and VOD systems by using short cycle burst transmission of audio/video programming. Walters teaches the cyclic distribution of audio/video program information in a burst of time that is substantially less than the time required for real-time viewing of that audio/video programming. This method takes advantage of the lower costs associated with NVOD systems, while providing more content and in some instances VCR-type control to the user.

Walters teaches an apparatus that includes a central library storing a multiplicity of time compressed digital audio/video programs that may be selectively transmitted in a burst time period to corresponding storage at one or more remote subscriber locations where the program would be decompressed and viewed. The central library provides cyclic, predetermined transmission of the programs, and a receiver at the user's location continuously monitors the communications channel over which the sequential stream of compressed program data is broadcast, but stores only the programs that have been ordered by the user.

The method and apparatus taught by Walters, however, is a point-to-point transmission system, which requires the allocation of a specific communications channel in an ATM (asynchronous transfer mode) network, for transmission of the program data at a relatively high cost. In addition, because the method selectively stores only the program or programs ordered by the user, the transmission cycles must be extremely short to avoid delays between the time a program is ordered and the time it is delivered to the customer. Short transmission cycles require frequent retransmission of the same data, seriously limiting the number of different programs that can be offered per communications channel and resulting in significant inefficiencies and underutilization of bandwidth.

Broadcasting is the most effective way to deliver popular media to a mass audience because it is a one-to-many distribution method wherein the bandwidth capacity is not dependent on the number of users tuned to a given broadcast. For example, local television stations broadcast the same TV show to every home at the same time. Content providers can distribute popular programs to millions of people at the same time, and at the same speed. Whether a telecast is viewed by one or one hundred households, the cost of transmission via the established broadcasting network is the same.

Until recently, broadcasting has also presented significant limitations as a means for the distribution of rich digital content, including lack of methods and apparatus for economically and efficiently using broadcast bandwidth, lack of methods and apparatus for receiving and managing content, and lack of a standardized digital broadcasting infrastructure, and in particular a standardized wireless digital broadcasting infrastructure. In response to legislation, television stations have now established a significant digital broadcast infrastructure, which will continue to develop over time. However, the existing capacity and infrastructure of digital broadcasting are currently under-utilized by the television broadcast networks.

### SUMMARY OF THE INVENTION

The present invention takes advantage of the existing digital broadcast capacity and infrastructure, and overcomes the remaining limitations in the prior art by taking advantage of non-deterministic (or “opportunistic”) unused bandwidth in dynamically optimized broadband broadcast systems and by using inexpensive storage devices for mass storage of digital data files received from broadcasts which can be viewed at a later time by the user. When viewed later by the user, the data is retrieved from the user's local disk storage at high speed, thereby overcoming the “last mile” bandwidth problem. The present invention does not require reservation of a particular communications channel or data transfer spectrum. Instead, data is opportunistically “piggybacked” onto unrelated broadcasts, using otherwise unused bandwidth within existing broadcast channels or spectrums. The broadcast source does not target the digital files at specific identifiable users or broadcast contents based on their interactive requests.

In one aspect of the present invention, it possesses at least the following characteristics:

a. non-deterministic schedule and bandwidth; the present invention uses the same channels that are being used for regular broadcasting by the stations, and need not create new channels, in a non-deterministic schedule and bandwidth fashion;

b. enhancement of a medium designed for one use (e.g., audio-video programming) by other uses (e.g., movies game download);

c. orthogonal revenue stream, in that more video programs or more fidelity do not increase advertising revenue; the services provided in accordance with the present invention create a new revenue stream for broadcast stations (or satellite or digital cable provider, etc.); and

d. extremely useful for delivering relatively large and/or highly demanded files of digital content simultaneously to many users, such as video, audio, game, software, and web content.

Data broadcasting in accordance with the present invention may be implemented to work with any medium which allows the delivery of large files in a one-to-many fashion (i.e., “broadband broadcast medium”), such as digital cable, digital broadcast satellite, terrestrial digital television, and computer networks that are broadcast-enabled and sufficiently broadband. In one aspect of the present invention, data broadcasting is conducted via wireless transmissions. In a further aspect of the present invention, data broadcasting is conducted via wireless transmissions based on unused bandwidths in audio-visual broadcasting such as terrestrial digital television broadcasting.

### BRIEF DESCRIPTION OF THE DRAWINGS

FIG. 1 is a block diagram of the digital data broadcasting architecture in accordance with the present invention.

FIG. 2 is a schematic diagram illustrating a data broadcasting network configured in accordance with one embodiment of the present invention.

FIG. 3 is a block diagram showing the functional components of the publishing services, transport services, subscriber services, and back office services, corresponding to the overall architecture of the data broadcasting network in accordance with one embodiment of the present invention.

FIG. 4 is a block diagram showing the interactions of the functional components of the various services to handle information flow for the overall architecture of the data broadcasting network in accordance with one embodiment of the present invention.

FIG. 5 is a schematic diagram of a local television station.

FIG. 6 is a block diagram illustrating the use of opportunistic bandwidth in an IP-based network.

FIG. 7 is a schematic diagram further illustrating IP encapsulation of two digital data streams.

FIG. 8 is a block diagram illustrating the primary receiver hardware components.

FIG. 9 is a block diagram illustrating the architecture of a receiver/storage device in accordance with one embodiment of the present invention.

FIG. 10 is a functional block diagram illustrating the client architecture of the data broadcasting network in accordance with one embodiment of the present invention.

FIG. 11 is a block diagram showing the basic data groups used in the preferred embodiment.

FIG. 12 is a flow chart illustrating the flow of data from reception to scheduling for acquisition.

FIG. 13 is a flow chart illustrating the flow of data from scheduling for acquisition to storage.

### DETAILED DESCRIPTION OF THE PREFERRED EMBODIMENTS

The present description is of the best presently contemplated mode of carrying out the invention. This description is made for the purpose of illustrating the general principles of the invention and should not be taken in a limiting sense. The scope of the invention is best determined by reference to the appended claims.

The present invention substantially overcomes the bandwidth limitations in the prior art data mass distribution systems, and reduces the difficulties and disadvantages associated with other techniques of distribution of rich media digital content. To facilitate an understanding of the principles and features of the present invention, they are explained herein below with reference to its deployments and implementations in illustrative embodiments. By way of example and not limitation, the present invention is described herein below in reference to examples of deployments and implementations in the TV broadcast environment. The present invention can find utility in a variety of implementations without departing from the scope and spirit of the invention, as will be apparent from an understanding of the principles that underlie the invention.

The detailed descriptions that follow are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated.

Useful devices for performing the software implemented operations of the present invention include, but are not limited to, general or specific purpose digital processing and/or computing devices, which devices may be standalone devices or part of a larger system. The devices may be selectively activated or reconfigured by a program, routine and/or a sequence of instructions and/or logic stored in the devices. In short, use of the methods described and suggested herein is not limited to a particular processing configuration.

It is noted that in prior publications, the terms “broadcast” and “data broadcast” are used in a different context as compared to the invention described herein. For example, in U.S. Pat. No. 5,710,970 to Walters discussed in the Background section, it describes a point-to-point data transmission system, which is not a true one-to-many broadcast system. It is therefore unrelated to data broadcasting as in the present invention.

Prior to discussing the details of the inventive aspects of the present invention, it would be helpful to define some of the terms in the context used throughout this specification:

bandwidth: The amount of data that can be transmitted via a given channel within a given time.

broadcast: To make a signal available via a data mass distribution system to any receiver configured for bitstream selection, such as by frequency tuning to the data broadcast channel, IP address listening, multicast group joining, and/or analogous processes.

multicast: To send a signal to multiple receivers.

unicast: To send a signal to a receiver.

computer network: A bi-directional communications, data exchange and resource sharing system created by linking two or more computer nodes and establishing standards, or protocols, so that they can work together. A computer network may also serve as a broadcast network in uni-directional data mass distribution.

broadcast network: A uni-directional data mass distribution system created by linking two or more broadcasting stations or intermediary stations, for broadcasting content over a wide area.

channel: A path along which data is transmitted in a data mass distribution system; a broadcast channel may be associated with a particular data transmission frequency span, a particular IP address, an IP multicast address, and/or analogous bitstream selection means.

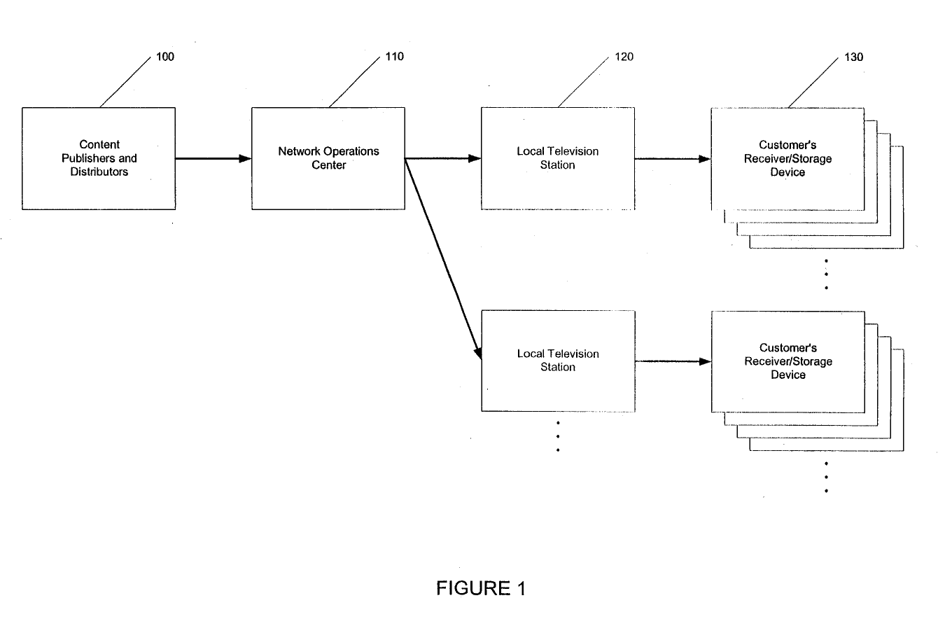

Referring now to FIG. 1, there is shown a block diagram illustrating the basic architecture of the digital content broadcasting system in accordance with the present invention. Rich media content, including without limitation, movies, music, video games, software and publishing, is provided by content publishers or distributors 100 to the network operations center 110. The network operations center 110 processes and formats the content data and provides it to local television stations 120. The local television stations 120 then opportunistically broadcast the content to receivers/storage devices 130 where it is stored for use by the customers.

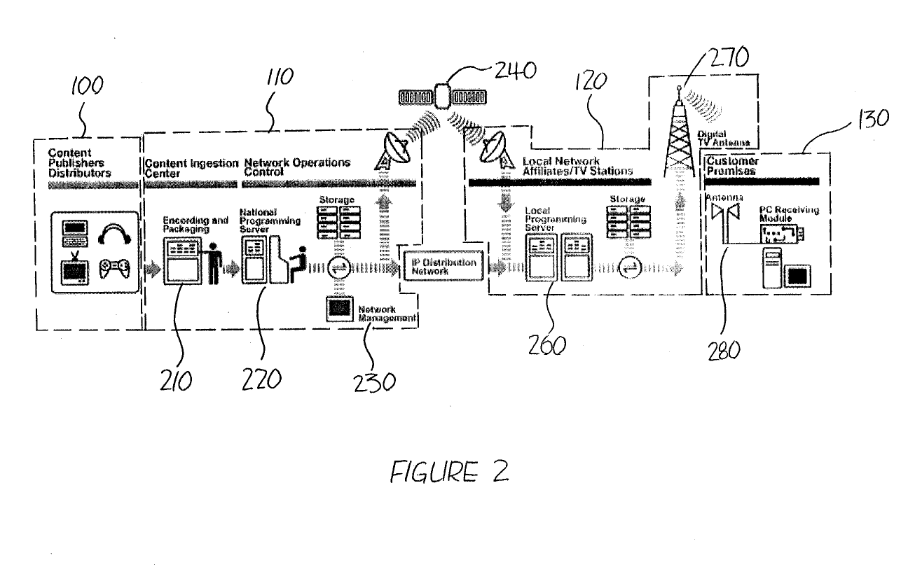

Referring now to FIG. 2, there is shown a more detailed schematic illustration of the distribution system used to implement the present invention. Rich media content is first provided by the publisher or distributor to the content ingestion center 210, where the data comprising the content is staged and packaged as described more fully below. The content can be provided in any form, including physical media such as digital versatile disk (“DVD”), CD-ROM and magnetic media, as well as networked media such as satellite and Internet connectivity.

The packaged and staged data is then stored to the national programming server 220 by network management 230. The network operations center 110 then distributes the staged data packets to local television stations 120 or local station nodes via a virtual private network (“VPN”) using satellite and terrestrial bandwidth providers 240.

Each local television station 120 will be equipped with network equipment that interconnects the local node to the VPN and stores the staged data packets received from the network operations center 110. The network equipment will interface with the local programming server 260 to manage subsequent broadcast by means of a digital television data injector and a digital television antenna 270, as described more fully below.

The data broadcast is then picked up by the antenna 280 of the user's receiver/storage device 130 and is stored in the receiver/storage device until accessed by the user. The receiver/storage device will initially be a universal serial bus (“USB”) appliance or a PCI card attached to a computer with a standard web browser and network application software. Over time, it is anticipated that receiver/storage devices will be integrated into personal computers and other digital devices, including digital televisions, Internet appliances, mobile digital computing products and personal digital recorders (“PDR”, such as the TiVo system).

Overall, data packets in time domain in MPEG format are scrambled and transmitted at the transmitter end. The data packets are unscrambled to time domain at the receiver end. The data staging and packetizing process will now be described in more detail. When digital content arrives at the content ingestion center 210, it is downloaded onto a secure storage system. It is then staged with a variety of information as requested by the content provider, including metadata and any content protection. The data is then IP protocol encapsulated (using for example ATSC A/90 standard or DVB MPE—EN 301 192—standard), so that the resulting packetized, staged data can be throughput to the national programming server 220. At the network operations center, the metadata (including an announcement stream and user interface data) are updated and the packetized staged data is prepared for distribution to the local nodes or local television stations through the VPN described above. The announcement stream contains information about the data being broadcast, allowing the receiver to select the data of interest; it is associated with the meta-data ascribed to the data content. The transmitter metadata mirrors the receiver metadata, including, for example, information identifying the content provider, the acquisition priority, a profile for the transmission group, content categories and type subgroups, channel and packet identification, start-time, end time, storage information (e.g., purging information), file descriptor, application usage, action to be undertaken, and cache management information, etc.

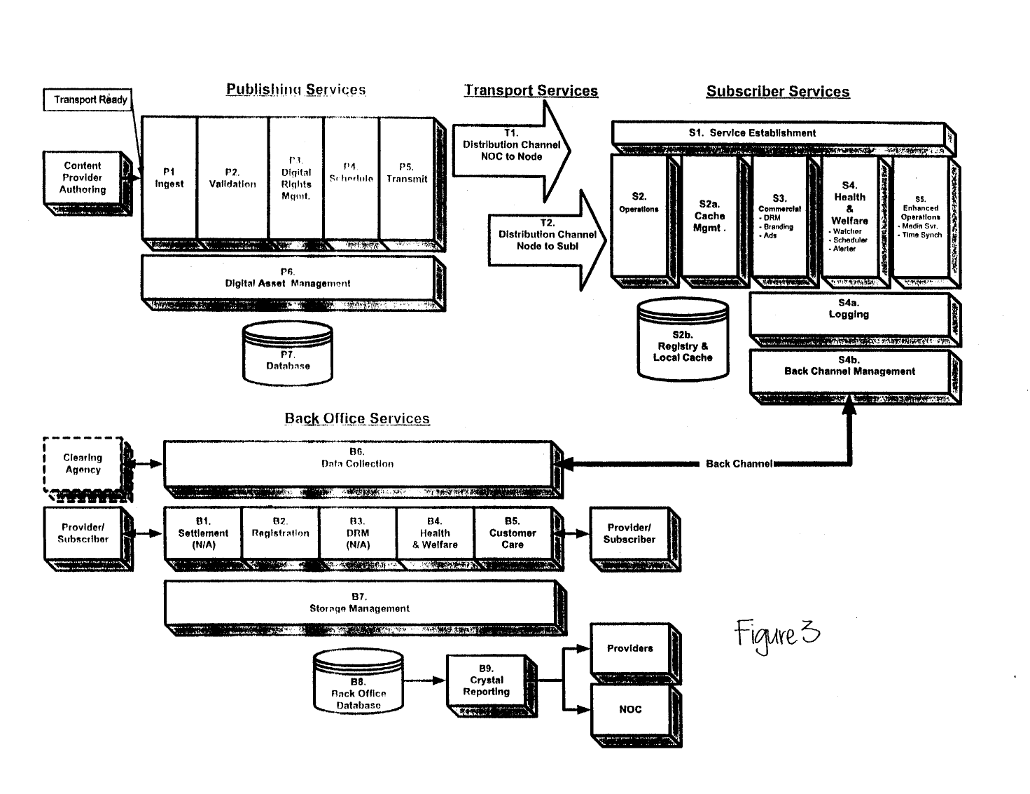

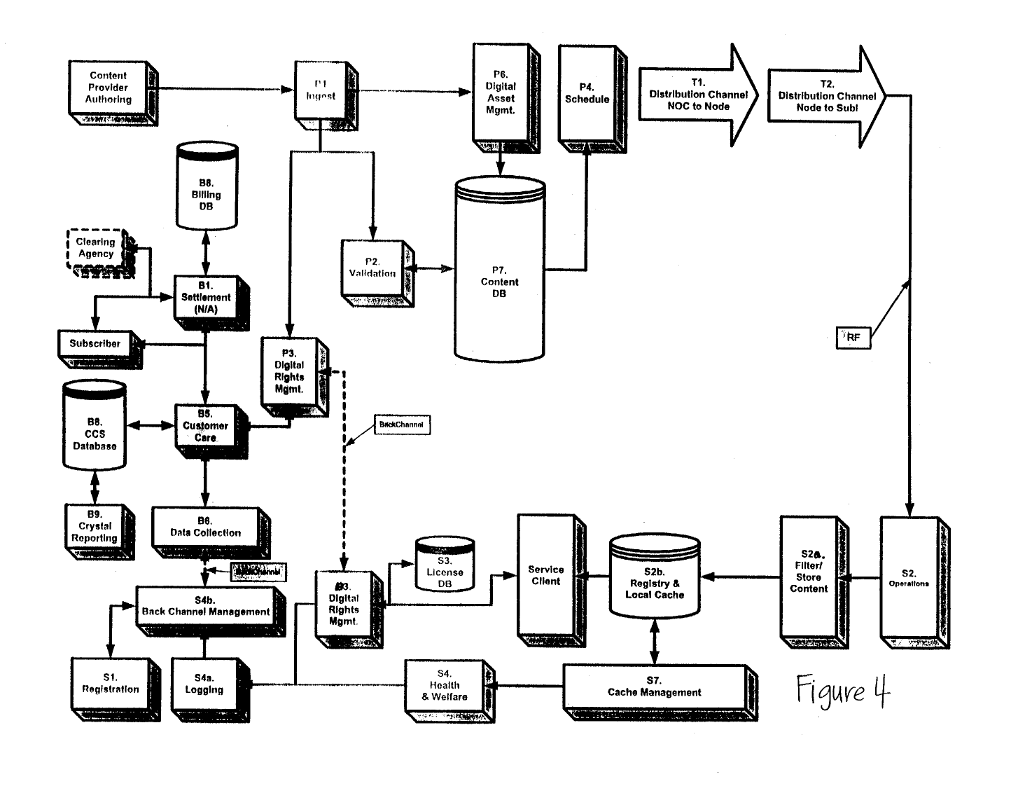

FIG. 3 is a block diagram showing the functional components of the publishing services, transport services, subscriber services, and back office services, corresponding to the overall architecture of the data broadcasting network. FIG. 4 is a block diagram showing the interactions of the functional components of the various services to handle information flow for the overall architecture of the data broadcasting network. Referring also to FIG. 2, the publishing services, subscriber services, and back office services may be implemented at the network operations center 110.

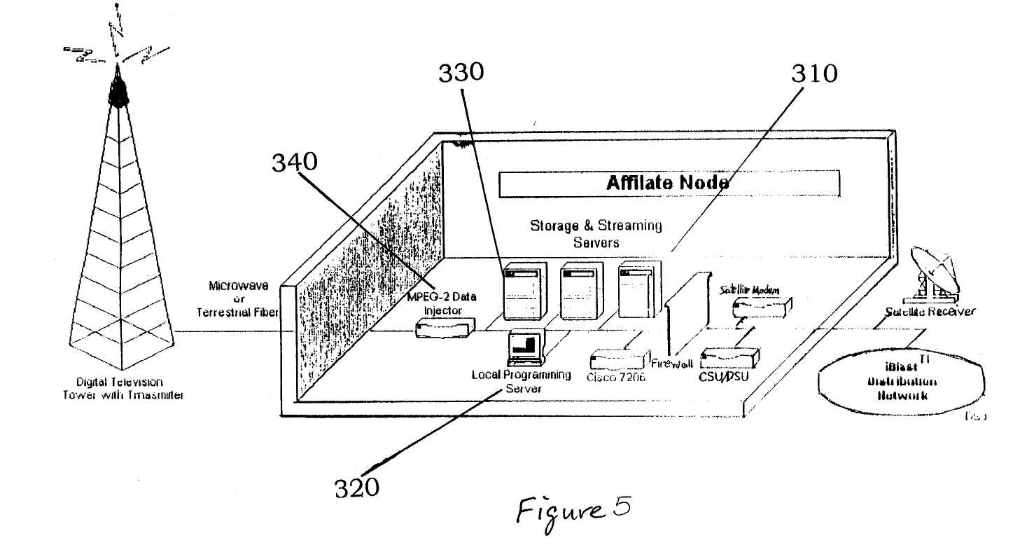

Referring now to FIG. 5, the operation of a local station or node will be described in more detail. Once the packetized staged data has been distributed out to the local nodes or local television stations through the VPN described above, the local nodes store the packetized staged data to be broadcast on secure servers 310. The local programming server 320 manages the packetized data and controls its insertion into the broadcast stream using data transmission engines 330 and a digital television data injector 340.

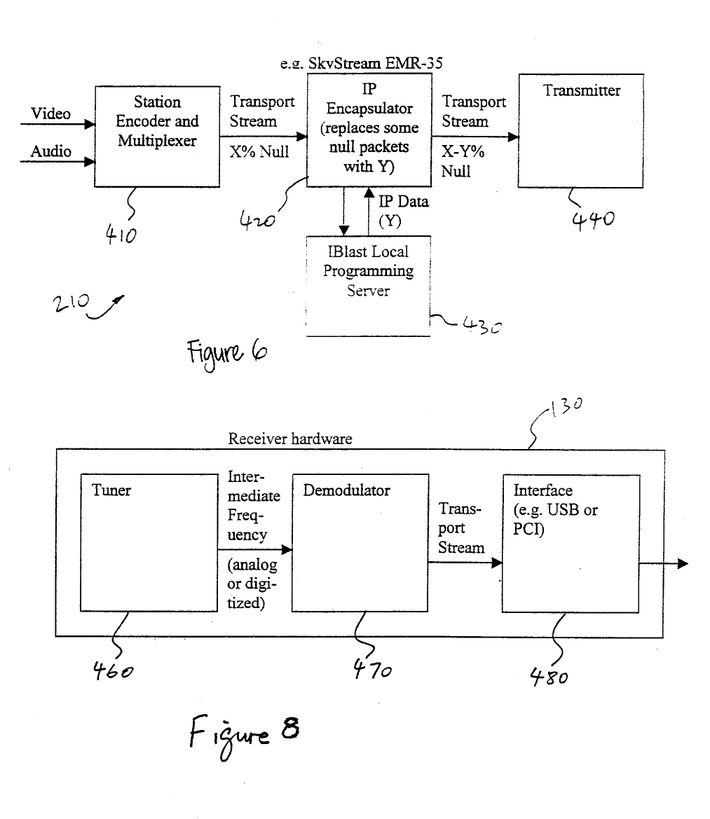

Referring now to FIG. 6, the injection of the packetized staged data into the digital broadcast stream will be described in more detail. For broadcasting, the network utilizes excess bandwidth in the 19.4 Mbps ATSC Broadcast Transmission system of this embodiment. Data is opportunistically inserted into the MPEG stream by encapsulating the IP datagrams into MPEG packets using the Multi-Protocol Encapsulation specification found in the DVB specification EN 301 192. To complement the transmission, the ATSC receiver/storage device discussed below is responsible for providing and creating all routines, such as DirectShow filter graphs, such that the encapsulated IP datagrams are rendered to the IP stack. (DirectShow is a Microsoft Windows-specific implementation. Other equivalent or substitute methods exist on other platforms, e.g., set-top boxes.) It will be seen that this allows the local node or station to manage and transmit any IP based content, while simultaneously allowing multiple standard definition television signals or a single high-definition television signal over the ATSC 8-VSB transmission standard (a part of the ATSC A/53 standard).

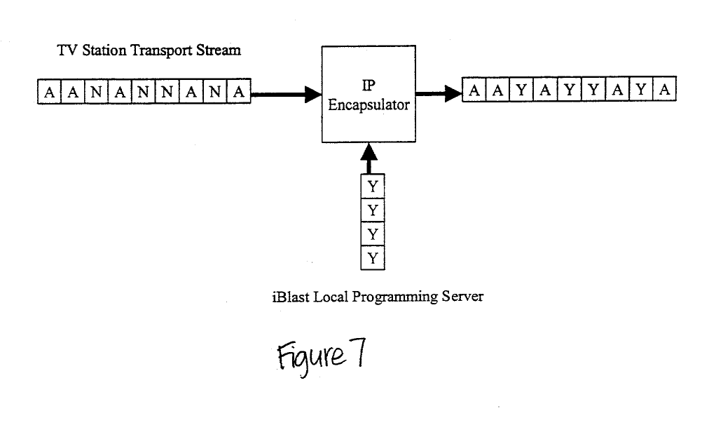

Referring specifically to FIG. 6 and FIG. 7, at the content ingestion center 210, content including video and/or audio are processed by a station encoder and multiplexer 410 to produce a transport stream (A) having X % null (N) packets. An IP Encapsulator replaces some null packets with content packets (Y) to produce a transport stream of XY % null packets, which is transported by a transmitter 440 downstream of the system. A local programming server 430 (e.g., an “iBlast” server operated by the assignee of the present invention) communicates with the IP Encapsulator 420 and provides the IP data (Y) to the IP Encapsulator 420.

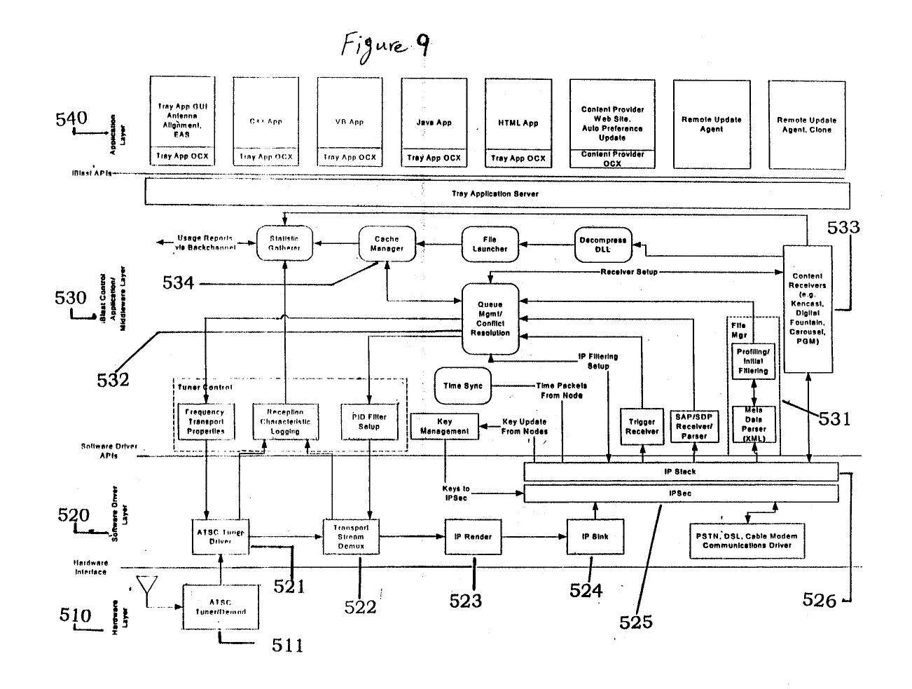

Referring to FIG. 8, at the receiver, a tuner 460 outputs a signal of intermediate frequency (which could also be a baseband frequency—depends on particular demodulator chip used), which is demodulated by a demodulator 470 into a transport stream. An interface 480 such as a USB or PCI based interface couples the transport stream for further processing and/or storage. In certain implementations, a hardware demultiplexer exists between demodulator 470 and interface 480. The hardware demultiplexer reduces software processing requirements.

The operation of the receiver/storage device will now be described in more detail. As set forth above, the receiver/storage device will initially be a universal serial bus (“USB”) appliance or a PCI tuner card attached to a computer with standard web browser and network application software. It is anticipated that a wide variety of digital devices will be developed to function as receiver/storage devices, including digital televisions, set-top boxes, internet appliances and mobile digital computing products.

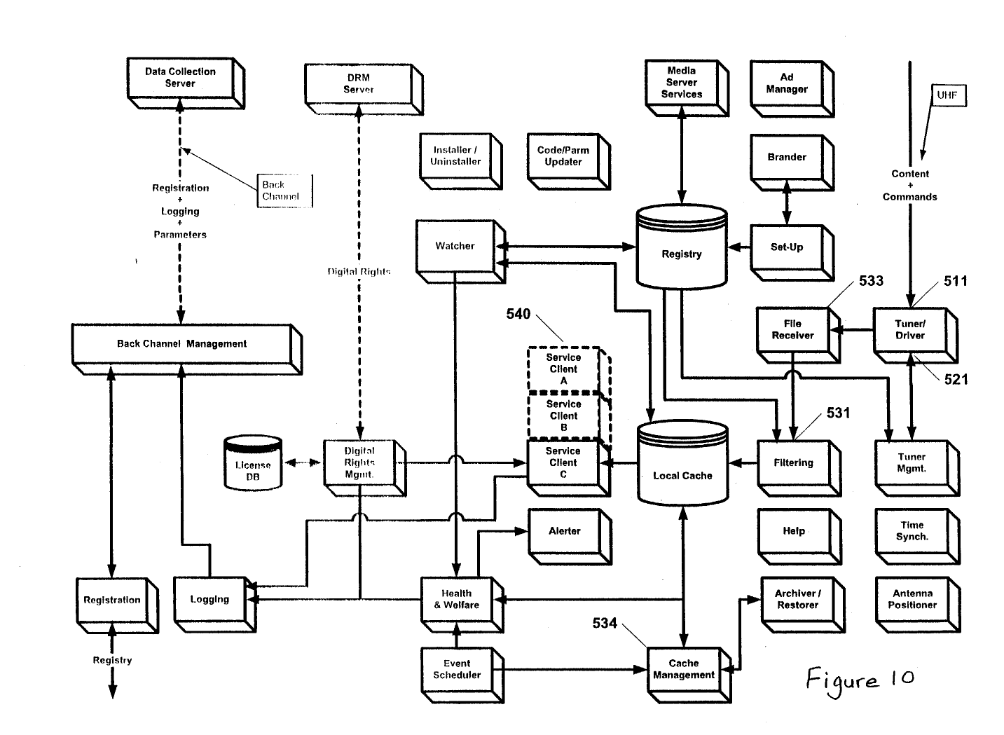

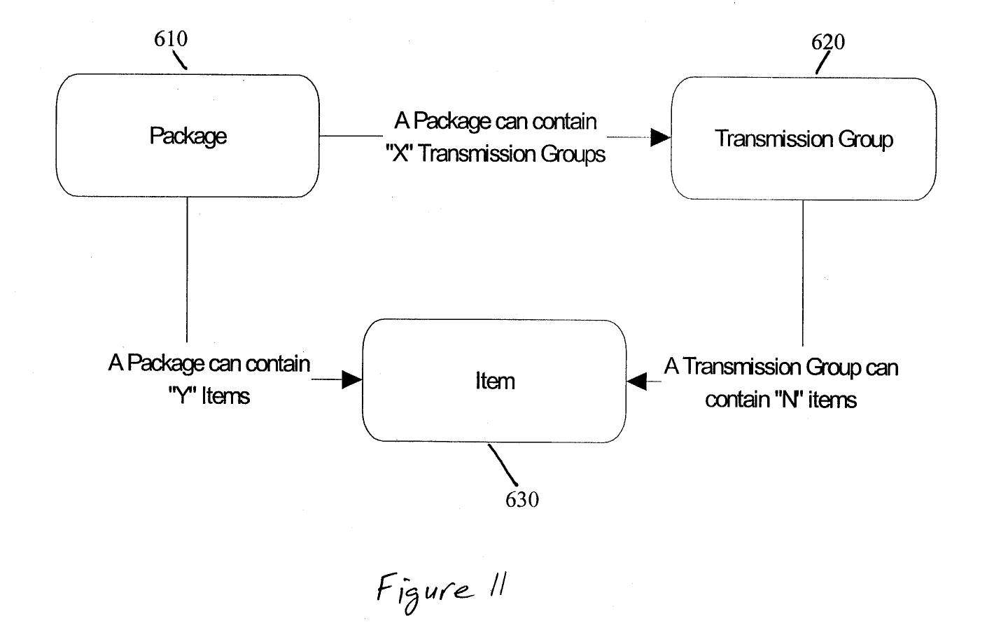

Referring now to FIG. 9, the architecture of the receiver/storage device is made up of four (4) distinct layers: hardware layer 510, software driver layer 520, middleware layer 530 and application layer 540. The hardware layer consists of an ATSC tuner demodulator 511, in some instances equipped with a smart steerable antenna for locations with multiple transmitters. The software driver layer 520 consists of an ATSC tuner driver 521, transport stream demultiplexor 522, IP renderer 523, an IP sink 524, an IP security module 525, and an IP stack 526. The ATSC tuner driver sets the reception frequency and controls the ATSC tuner for channel selection. As illustrated in FIG. 10, the software driver layer 520 directs the flow of incoming content data, demultiplexes the content packets from the main data stream using either software or hardware demultiplexing, and moves it into the IP stack together with other incoming content from direct Internet connections for handling by the middleware layer.

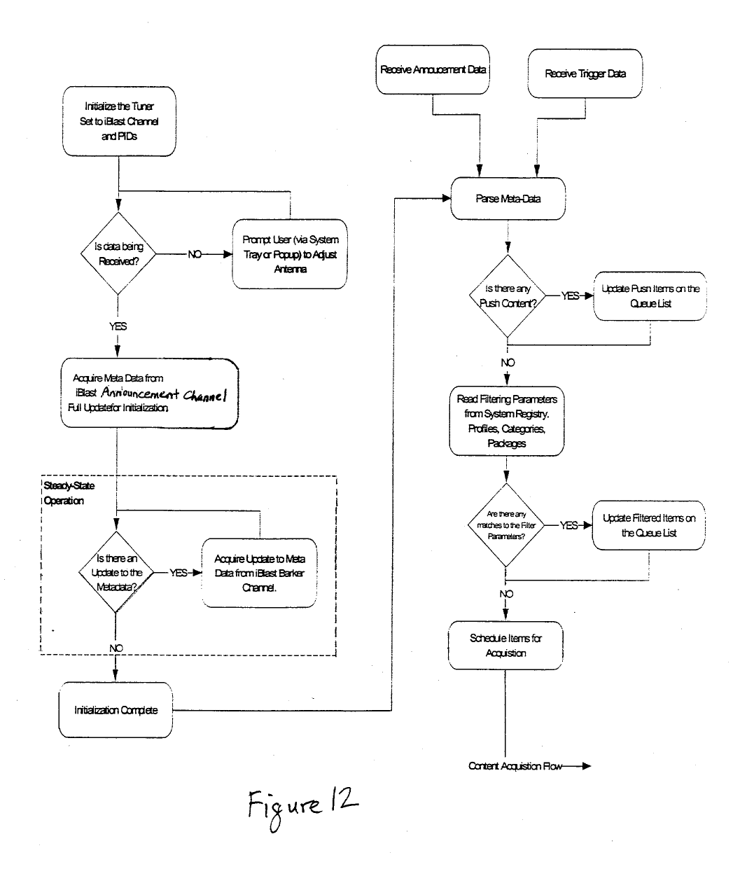

The middleware layer 530 controls all content data acquisition and management for the receiver/storage device. The middleware layer 530 is a meta-data driven application. To understand the operation of the middleware layer 530, it is helpful to understand how the content data is organized for transmission. Referring now to FIG. 11, a package 610 contains one or more transmission groups 620. A transmission group 620 contains one or more items 630 and each transmission group 620 has a unique identification (“ID”) code. An item 630 is a unique piece of content, which may be an individual file such as a movie, or a collection of files such as a web site.

Using identifying meta-data in the incoming data packets, the middleware 530 can tune to a particular channel, identify the available transmission groups 620, select which transmission groups 620 to capture, and manage the cache memory where incoming data is stored. Meta-data tags must be provided for all transmission groups 620 to define the reception attributes for the items in each transmission group 620. Meta-data tags are optional on packages of transmission groups 620 and on items. If an item arrives without meta-data, the middleware will create a minimum set of meta-data automatically.

Transmission group 620 meta-data tags contain critical information and commands used by the middleware to manage the operation of the receiver/storage device. For example, transmission group 620 tags may include information identifying the content provider, the acquisition priority to resolve conflicts in acquiring content from different channels, a profile for the transmission group 620, content categories and type subgroups, channel and packet identification, start-time, end time and purging information.

Referring again to FIG. 9, the general operation of the middleware 530 in managing reception and storage of content will be described further. Once the ATSC tuner 511 has been set to a proper channel and data is being received, the middleware 530 acquires or updates meta-data from the announcement stream, which is present on all frequencies used by the network, and is identical across all frequencies, since it describes all data concerning the broadcasts at all frequencies in a given market. In other words, it aggregates meta-data across all broadcast network stations in a given market. This allows the receiver to ascertain all available data concerning the broadcasts at all frequencies by tuning to only one channel at one time. This meta-data file is transmitted on a periodic basis and provides configurable look-ahead capability, which in this embodiment is on the order of several days, to allow planning for content acquisition well in advance and to allow the user to look up the acquisition queue when the receiver/storage device is powered up.

The meta-data file is fed to the file manager 531 for meta-data parsing and initial profiling and filtering of data to identify and schedule transmission groups 620 for acquisition. Together with trigger data and announcement data, this information is fed to the queue management and conflict resolution manager.

FIG. 10 is a functional block diagram illustrating the client architecture of the data broadcasting network in accordance with one embodiment of the present invention. This diagram shows the interaction of the functional blocks of the receiver described in connection with FIG. 9 and the subscriber servers (see FIG. 3), and additional functions that complement the system. As can be seen, some of the functional blocks in FIG. 10 were described above in connection with FIG. 9.

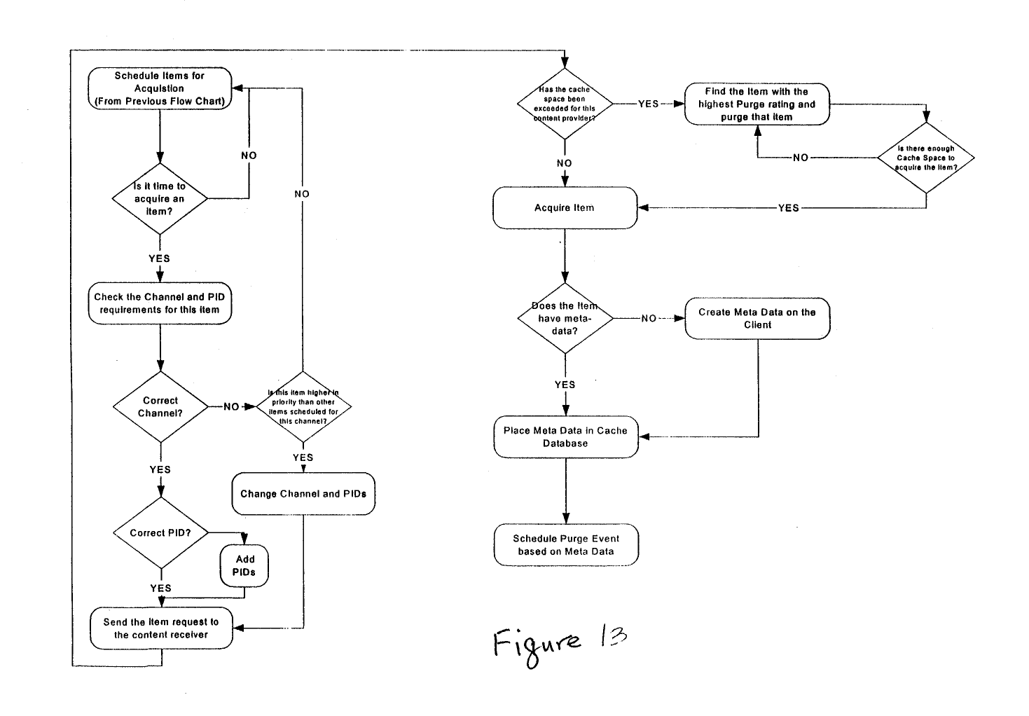

FIG. 12 illustrates this operational flow to the queue management conflict resolution manager 532. Metadata schedule, PID, and channel information is updated using SAP/SDP packets broadcast on approximately an hourly basis. In another embodiment, XML is used as the metadata format.

Referring now to FIG. 13, the operational flow from queue list creation to storage is illustrated. When the time to acquire a transmission group 620 in the acquisition queue arrives, the middleware 530 checks the channel and PID information, resolves any scheduling conflicts, then sends the acquisition request to the content receiver 533. The cache manager 534 checks to determine whether there is sufficient cache space for the acquisition, and purges the lowest priority items in the cache to make room and/or requests more cache room (e.g., from the system or the user). Once sufficient room is available, the transmission group 620 is acquired. Items 630 in the transmission group 620 are checked for meta-data, and if not present it is created. The meta-data for each item 630 is then placed in the cache database and purge events are scheduled. In another embodiment, the cache manager “sweeps” the cache on a regular basis to comply with metadata-specified requirements of, e.g., total cache size.

The content receiver 533 reassembles and stores the content in the cache on, e.g., hard disk. Other media for storage may be used instead, such as RAM, magnetic media, DVD, CD ROM or a combination of such media. This content is then accessed by the user through the application layer 540, using standard Internet and PC application programs.

The middleware layer 530 also provides for collection of statistics, IP security controls, and communication with the network via an Internet back-channel. The cache is managed based on the amount of storage available, the priority assigned to stored content and purge instructions, if any, for particular items.

In this embodiment, the network will opportunistically broadcast different content simultaneously on a plurality of channels or frequencies. The meta-data file will be broadcast on all channels or frequencies, as will metadata updates provided in SAP/SDP packets (latter not required). In an alternate embodiment, XML will be used instead of SAP/SDP. This system provides for the one-to-many transmission of huge quantities of content data, on a flexible schedule (may be predetermined, periodic, or opportunistic) that can be updated or revised. Data transmission speeds exceed other broadband connections such as cable modem and DSL by approximately 18× and dial up connections by approximately 125×, at substantially lower costs per megabyte of data. By opportunistically accessing unused digital spectrum, the invention allows each local television station in the network to broadcast additional rich media digital content in large file sizes in any given day without requiring additional bandwidth. For example, for a given ATSC broadcast station that broadcasts video 24-hour-a-day averaging about 4 megabits per second (which leaves roughly 15 megabits per second unused), the invention can broadcast upwards of 150 gigabytes per day. A minimum of 75 gigabytes of data per day can be achieved quite readily. For markets with multiple local stations, minimum distribution of multiples of 75 to upwards of 150 gigabytes of data or more per day are possible.

It will be appreciated that this embodiment is only one implementation of the invention, which involves a national or regional broadcast network. The invention could also be implemented in a local system employing the same basic elements of content ingestion, staging and packetizing the data, cyclical data injection and broadcast, and reception and storage management without departing from the scope and spirit of the invention.

References are made to the following publications by iBlast, Inc., the assignee of the present invention, concerning data broadcasting: (1) A Standards-based Data Broadcasting Network, by Pete Lude (SMPTE Pasadena, Calif. Oct. 19, 2000); (2) Balancing Bandwidth and Bytes: Managing storage and transmission across a datacast network, by Pete Lude and Dan Radke; and (3) iBlast Data Broadcasting Field Tests—A Study to Understand and Quantify Reception of the ATSC Signal, by Andrew Miller et al. (Apr. 23, 2001). These publications were available on iBlast's website (http://www.iblast.com) at least as early as Apr. 23, 2001 (the filing date of the present application), and are fully incorporated by reference as if fully set forth herein.

While the invention has been described with respect to the described embodiments in accordance therewith, it will be apparent to those skilled in the art that various modifications and improvements may be made without departing from the scope and spirit of the invention. For example, the inventive concepts herein may be applied to wired or wireless system, based on IP, or other protocols, for entertainment, business, commercial or other types of digital content applications, without departing from the scope and spirit of the present invention. Accordingly, it is to be understood that the invention is not to be limited by the specific illustrated embodiments, but only by the scope of the appended claims.

1. A method of distributing a digital data file, comprising the steps of:
broadcasting a digital broadcast stream in a broadband digital broadcast channel; and
simultaneously broadcasting the digital data file using unused bandwidth within the broadband digital broadcast channel.

2. A method as in claim 1, wherein the digital data file is broadcast independent of an identifiable target user.

3. A method as in claim 1, wherein the digital data file is broadcast independent of a user request.

4. A method as in claim 1, wherein the digital broadcast stream is broadcast at a predetermined schedule, and wherein the digital data file is broadcast at a time independent of said predetermined schedule even though the digital data file happens to be broadcast with the digital broadcast stream.

5. A method as in claim 1, wherein the digital broadcast stream is broadcast at a predetermined schedule, and wherein the digital data file is broadcast at a time undeterministically with respect to said predetermined schedule.

6. A method as in claim 1, wherein content of the digital data file is unrelated to content of the digital broadcast stream.

7. A method as in claim 1, wherein the content of the digital data file and the digital broadcast stream are unrelated as to at least one of type of content, intended use of the content, or program category if content is programming.

8. A method as in claim 1, wherein the unused bandwidth is non-deterministic with respect to a particular broadband digital broadcast channel.

9. A method as in claim 1, wherein the digital data file is broadcast independent of association with a particular broadband digital broadcast channel.

10. A method as in claim 1, wherein the step of broadcasting digital broadcast stream is implemented via at least one of broadband wireless transmission and wired transmission.

11. A method as in claim 10, wherein the step of broadcasting digital broadcast stream is implemented via at least one of the following broadband data transmission systems: digital cable, digital broadcast satellite, terrestrial digital television, broadcast-enabled information exchange computer network.

12. A method as in claim 1, further comprising the step of packaging the digital data file prior to simultaneous broadcasting with the digital broadcast stream.

13. A method as in claim 12, wherein the step of packaging comprises at least one of the following steps:
associating broadcast meta-data with the digital data file; and
transmission protocol encapsulation.

14. A method as in claim 13, wherein the transmission protocol encapsulation step comprises the step of encapsulating IP packets within broadcast data packets.

15. A method as in claim 13, wherein the meta-data comprises at least one of the following data:
content provider;
acquisition priority;
transmission group profile;
content categories and type subgroups;
channel identification;
packet identification;
start-time;
end time;
storage information;
file descriptor;
application usage;
action to be taken; and
cache management information.

16. A method as in claim 13, further comprising the step of broadcasting an announcement stream that comprises meta-data that mirror that of the broadcast metadata.

17. A method of broadcasting a digital data file, comprising the steps of:
broadcasting at least one digital broadcast stream in at least one of a plurality of broadband digital broadcast channels; and
simultaneously broadcasting the digital data file using an unused bandwidth undeterministically within at least one of the broadband digital broadcast channels in which a digital broadcast stream is broadcast.

18. A method as in claim 17, wherein the digital data file is staged with meta-data representing the attributes of the digital data file and the specific broadband digital broadcast channel in which the digital data file is to be broadcast;

19. A method as in claim 17, wherein a plurality of digital broadcast streams are broadcast at different schedules, and wherein the digital data file is broadcast at a time underterministically with respect to said schedules.

20. A method of distributing a digital data file, comprising the steps of:
broadcasting at least one digital broadcast stream in a broadband digital broadcast channel at a particular schedule, wherein different digital broadcast streams may be broadcast at different schedules; and
simultaneously broadcasting the digital data file using an unused bandwidth within the broadband digital broadcast channel undeterministically with respect to the schedules of the digital broadcast streams.

21. A method of transferring a digital data file, comprising the steps of:
broadcasting at least one digital broadcast stream in at least one of a plurality of broadband digital broadcast channels, wherein a plurality of digital broadcast streams may be broadcast at different schedules;
simultaneously broadcasting the digital data file using an unused bandwidth, at least one of undeterministically within one of the broadband digital broadcast channels in which a digital broadcast stream is broadcast and underterministically with respect to said schedules;
tuning to the digital broadcast stream;
selectively downloading the digital data file from the digital broadcast stream at the corresponding channel and schedule; and
at least one of storing the digital data file in a storage device, executing the digital data file, and utilizing the digital data file.

22. A method as in claim 21, wherein:
the step of broadcasting said digital broadcast stream comprises broadcasting an announcement stream comprising meta-data relating to the attributes of the digital data file, including at least one of identification of the digital data file, time of broadcast and channel of broadcast;
the method further comprising the steps of downloading from the digital broadcast stream the announcement stream; and
the meta-data in the announcement stream is relied upon to selectively download the digital data file from the digital broadcast stream at the corresponding channel.

23. A method as in claim 22, wherein a substantially identical announcement stream is broadcast in more than one available broadband digital broadcast channel, so that an announcement stream would be downloaded independent of the broadband digital broadcast channel tuned, whereby the downloaded announcement stream is relied upon to download the desired digital data file in the corresponding channel and schedule.

24. A method as in claim 23, wherein a substantially identical announcement stream is broadcast in all available broadband digital broadcast channels in a particular broadcast network.

25. A method as in claim 21, further comprising the steps of:
subsequently retrieving the digital data file from the storage device;
using the digital data file at a time independent of original step of broadcasting.

26. A method as in claim 25, wherein the digital data file comprises a rich media file, and wherein the step of executing comprises the step of playing the rich media file for user viewing.

27. A system for distributing a digital data file, comprising:
means for broadcasting a digital broadcast stream in a broadband digital broadcast channel; and
means for simultaneously broadcasting the digital data file using an unused bandwidth within the broadband digital broadcast channel.

28. A system for distributing a digital data file to end users via local television stations that broadcast digital broadcast streams at predetermined channels and schedule, comprising:
a content ingestion center having means for staging and packaging the digital file into staged data packets;
distributing means for distributing the staged data packets to the local television stations that serve the end users;
injecting means provided at the local television stations to inject the staged data packets into a digital broadcast stream in a channel that has available bandwidth; and
means for broadcasting the digital broadcast stream along with the digital data file indiscriminately to end users; and
tuners located at end users to tune into the channel to download the staged data packets, said tuners having means for decoding the staged data packets into the digital data file.

29. A system as in claim 28, wherein the injecting means inject the staged data packet into a digital broadcast stream undeterministically with respect to channel and schedule.

30. A system as in claim 28, wherein said tuner further having means for storing the digital data file.
